(19) United States
(12) Patent Application Publication
(10) Pub. No.: US 2020/0408345 A1
(43) Pub. Date: Dec. 31, 2020

(54) Condensate Drain Pipe Apparatus

(71) Applicant: John Tallman, Manahawkin, NJ (US)

(72) Inventor: John Tallman, Manahawkin, NJ (US)

(21) Appl. No.: 16/454,728

(22) Filed: Jun. 27, 2019

(51) Int. Cl. F16L 41/02

(52) U.S. Cl. CPC F16L 41/02

(57) ABSTRACT

A condensate drain pipe apparatus for providing drainage for a condensate pump includes a main drain having a main top end, a main bottom end, and a main sidewall extending therebetween. A dishwasher drain has a main end coupled to the main sidewall of the main drain, a dishwasher end, and a dishwasher sidewall extending therebetween. The dishwasher drain is in fluid communication with the main drain. The dishwasher drain extends perpendicularly from the main drain and the dishwasher end is configured to be coupled to a dishwasher drainage tube. A condensate drain has a drain end coupled to the dishwasher sidewall of the dishwasher drain, a hose end, and a condensate sidewall extending therebetween. The condensate drain is in fluid communication with the dishwasher drain and the hose end is configured to be coupled to a condensate pump hose.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

### Description of Related Art Including Information Disclosed Under 37 CFR 1.97 and 1.98

The disclosure and prior art relates to drain pipes and more particularly pertains to a new drain pipe for providing drainage for a condensate pump.

### BRIEF SUMMARY OF THE INVENTION

An embodiment of the disclosure meets the needs presented above by generally comprising a main drain having a main top end, a main bottom end, and a main sidewall extending therebetween. A dishwasher drain has a main end coupled to the main sidewall of the main drain, a dishwasher end, and a dishwasher sidewall extending therebetween. The dishwasher drain is in fluid communication with the main drain. The dishwasher drain extends perpendicularly from the main drain and the dishwasher end is configured to be coupled to a dishwasher drainage tube. A condensate drain has a drain end coupled to the dishwasher sidewall of the dishwasher drain, a hose end, and a condensate sidewall extending therebetween. The condensate drain is in fluid communication with the dishwasher drain and the hose end is configured to be coupled to a condensate pump hose.

In another embodiment, the invention includes a main drain having a main top end, a main bottom end, and a main sidewall extending therebetween. The main drain has a top lip extending around the main top end. A condensate drain has a drain end coupled to the main sidewall of the main drain, a hose end, and a condensate sidewall extending therebetween. The condensate drain extends perpendicularly from the main drain. The condensate drain has an extension portion extending from the drain end, a medial portion extending from the extension portion, and an attachment portion extending from the medial portion to the hose end. A diameter of the medial portion is greater than a diameter of the attachment portion and less than a diameter of the extension portion. The diameter of the extension portion is less than a diameter of the main drain. The condensate drain is in fluid communication with the main drain. The attachment portion is barbed and the hose end is configured to be coupled to a condensate pump hose.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a condensate drain pipe apparatus according to an embodiment of the disclosure.

FIG. 2 is a bottom plan view of an embodiment of the disclosure.

FIG. 3 is a rear elevation view of an embodiment of the disclosure.

FIG. 4 is a front elevation view of an embodiment of the disclosure.

FIG. 5 is a side elevation view of an embodiment of the disclosure.

FIG. 6 is an isometric view of an embodiment of the disclosure.

### DETAILED DESCRIPTION OF THE INVENTION

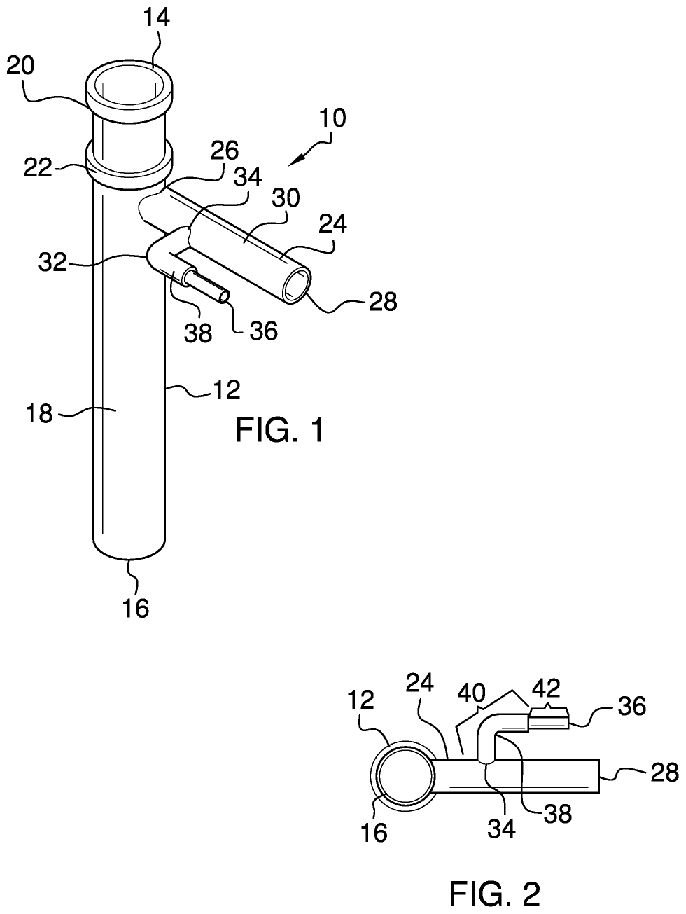

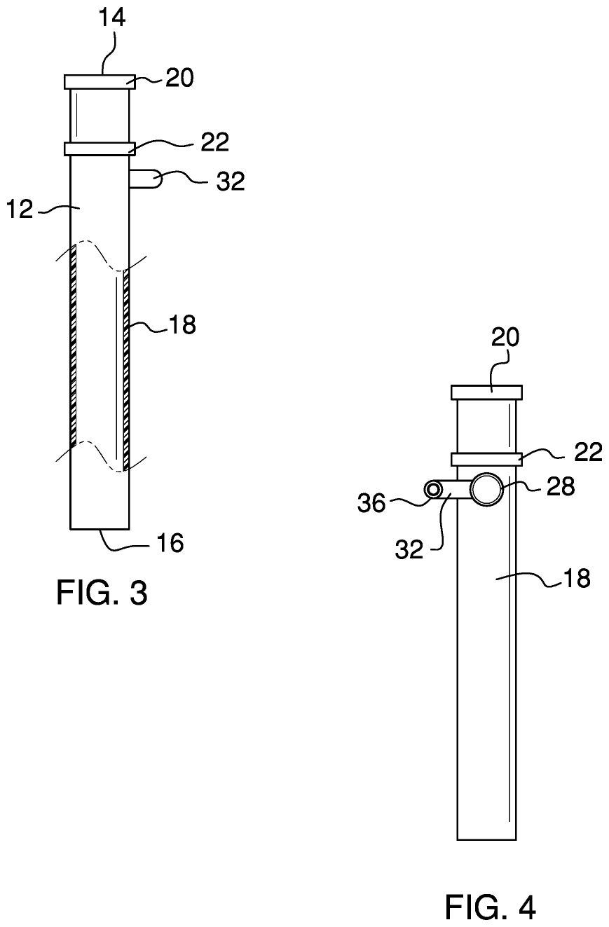

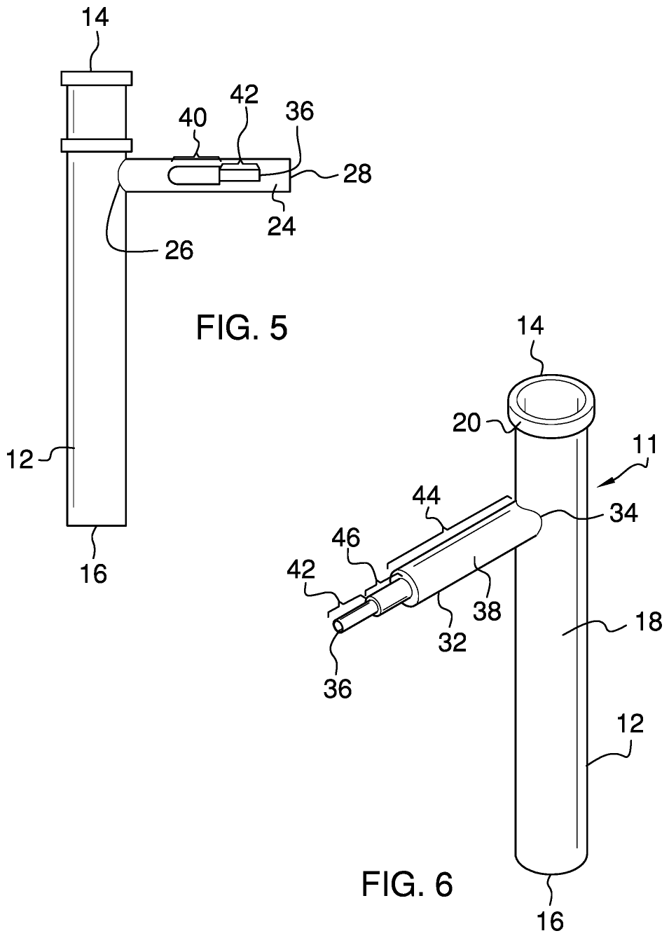

With reference now to the drawings, and in particular to FIGS. 1 through 6 thereof, a new drain pipe embodying the principles and concepts of an embodiment of the disclosure and generally designated by the reference numeral 10 will be described.

As best illustrated in FIGS. 1 through 6, the condensate drain pipe apparatus 10 generally comprises a main drain 12 having a main top end 14, a main bottom end 16, and a main sidewall 18 extending therebetween. The main drain 12 has a top lip 20 extending around the main top end 14 and a secondary lip 22 extending around the main sidewall 18 below the top lip 20. A dishwasher drain 24 has a main end 26 coupled to the main sidewall 18 of the main drain below the secondary lip 22, a dishwasher end 28, and a dishwasher sidewall 30 extending therebetween. A diameter of the dishwasher drain 24 is less than a diameter of the main drain 12 and the dishwasher drain 24 is in fluid communication with the main drain 12. The dishwasher drain 24 extends perpendicularly from the main drain 12. The dishwasher end 28 is configured to be coupled to a dishwasher drainage tube.

A condensate drain 32 has a drain end 34 coupled to the dishwasher sidewall 30 of the dishwasher drain, a hose end 36, and a condensate sidewall 38 extending therebetween. The condensate drain 32 is in fluid communication with the dishwasher drain 24. The condensate drain 32 has an elbow portion 40 extending from the drain end 34 and an attachment portion 42 extending from the elbow portion 40 to the hose end 36. The elbow portion 40 extends perpendicularly from the dishwasher sidewall 30 and bends 90° to orient the attachment portion 42 along an axis parallel to an axis of the dishwasher drain 24. The hose end 36 is closer to the main drain 12 than the dishwasher end 28 of the dishwasher drain. A diameter of the attachment portion 42 is less than a diameter of the elbow portion 40 and the diameter of the elbow portion 40 is less than the diameter of the dishwasher drain 24. The attachment portion 42 may be barbed and the hose end 36 is configured to be coupled to a condensate pump hose.

In an alternative embodiment 11, the drain end 34 is coupled directly to the main sidewall 18 of the main drain and the condensate drain 32 extends perpendicularly from the main drain 12. The condensate drain has an extension portion 44 extending from the drain end 34, a medial portion 46 extending from the extension portion 44, and the attachment portion 42 extends from the medial portion 46 to the hose end 36. A diameter of the medial portion 46 is greater than a diameter of the attachment portion 42 and less than a diameter of the extension portion 44. The diameter of the extension portion 44 is less than the diameter of the main drain 12. The condensate drain 32 is in fluid communication with the main drain 12.

In use, the main drain 12 is attached to a sink, the dishwasher end 28 is coupled to the dishwasher drainage tube, and the hose end 36 is coupled to the condensate pump hose. A worm drive clamp may be used to secure the condensate pump hose in place.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A condensate drain pipe apparatus comprising:
a main drain, the main drain having a main top end, a main bottom end, and a main sidewall extending therebetween;
a dishwasher drain coupled to the main drain, the dishwasher drain having a main end coupled to the main sidewall of the main drain, a dishwasher end, and a dishwasher sidewall extending therebetween, the dishwasher drain being in fluid communication with the main drain, the dishwasher drain extending perpendicularly from the main drain, the dishwasher end being configured to be coupled to a dishwasher drainage tube; and
a condensate drain coupled to the dishwasher drain, the condensate drain having a drain end coupled to the dishwasher sidewall of the dishwasher drain, a hose end, and a condensate sidewall extending therebetween, the condensate drain being in fluid communication with the dishwasher drain, the hose end being configured to be coupled to a condensate pump hose.

2. The condensate drain pipe apparatus of claim 1 further comprising the main drain having a top lip extending around the main top end.

3. The condensate drain pipe apparatus of claim 2 further comprising the main drain having a secondary lip extending around the main sidewall below the top lip, the main end of the dishwasher drain being coupled to the main sidewall below the secondary lip.

4. The condensate drain pipe apparatus of claim 1 further comprising the condensate drain having an elbow portion extending from the drain end and an attachment portion extending from the elbow portion to the hose end, a diameter of the attachment portion being less than a diameter of the elbow portion.

5. The condensate drain pipe apparatus of claim 4 further comprising a diameter of the dishwasher drain being greater than the diameter of the elbow portion and less than a diameter of the main drain.

6. The condensate drain pipe apparatus of claim 4 further comprising the elbow portion extending perpendicularly from the dishwasher sidewall and bending 90°, the attachment portion being oriented along an axis parallel to an axis of the dishwasher drain.

7. The condensate drain pipe apparatus of claim 4 further comprising the attachment portion being barbed.

8. The condensate drain pipe apparatus of claim 6 further comprising the hose end being closer to the main drain than the dishwasher end.

9. A condensate drain pipe apparatus comprising:
a main drain, the main drain having a main top end, a main bottom end, and a main sidewall extending therebetween, the main drain having a top lip extending around the main top end and a secondary lip extending around the main sidewall below the top lip;
a dishwasher drain coupled to the main drain, the dishwasher drain having a main end coupled to the main sidewall of the main drain below the secondary lip, a dishwasher end, and a dishwasher sidewall extending therebetween, a diameter of the dishwasher drain being less than a diameter of the main drain, the dishwasher drain being in fluid communication with the main drain, the dishwasher drain extending perpendicularly from the main drain, the dishwasher end being configured to be coupled to a dishwasher drainage tube; and
a condensate drain coupled to the dishwasher drain, the condensate drain having a drain end coupled to the dishwasher sidewall of the dishwasher drain, a hose end, and a condensate sidewall extending therebetween, the condensate drain being in fluid communication with the dishwasher drain, the condensate drain having an elbow portion extending from the drain end and an attachment portion extending from the elbow portion to the hose end, the elbow portion extending perpendicularly from the dishwasher sidewall and bending 90°, the attachment portion being oriented along an axis parallel to an axis of the dishwasher drain, the hose end being closer to the main drain than the dishwasher end, a diameter of the attachment portion being less than a diameter of the elbow portion, the diameter of the elbow portion being less than the diameter of the dishwasher drain, the attachment portion being barbed and the hose end being configured to be coupled to a condensate pump hose.

10. A condensate drain pipe apparatus comprising:
a main drain, the main drain having a main top end, a main bottom end, and a main sidewall extending therebetween, the main drain having a top lip extending around the main top end; and
a condensate drain coupled to the main drain, the condensate drain having a drain end coupled to the main sidewall of the main drain, a hose end, and a condensate sidewall extending therebetween, the condensate drain extending perpendicularly from the main drain, the condensate drain having an extension portion extending from the drain end, a medial portion extending from the extension portion, and an attachment portion extending from the medial portion to the hose end, a diameter of the medial portion being greater than a diameter of the attachment portion and less than a diameter of the extension portion, the diameter of the extension portion being less than a diameter of the main drain, the condensate drain being in fluid communication with the main drain, the attachment portion being barbed and the hose end being configured to be coupled to a condensate pump hose.
